(19) United States
(12) Patent Application Publication
(10) Pub. No.: US 2009/0250454 A1
(43) Pub. Date: Oct. 8, 2009

(54) METHOD FOR CONTROLLING INDUCTION HEATING DEVICES IN AN ELECTRIC COOKING APPLIANCE

(75) Inventor: Christian Egenter, Bretten (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. Elektro-Geraetebau GmbH

(21) Appl. No.: 12/478,206

(22) Filed: Jun. 4, 2009

Related U.S. Application Data
(63) Continuation of application No. PCT/EP2007/010540, filed on Dec. 5, 2007.

(30) Foreign Application Priority Data
Dec. 6, 2006 (DE) 10 2006 058 874.6

(51) Int. Cl. H05B 6/12

(52) U.S. Cl. 219/620

(57) ABSTRACT

A method and system for controlling four induction heating devices of a hob is described. In an embodiment of said method, the induction devices are connected to a power supply with three outer conductors, every outer conductor having a maximum load. Two induction heating devices are connected to an outer conductor via a common power section. If a first induction heating device is operated with a boost power and a second induction heating device with a lower rated power, the second induction heating device is operated in a prioritized manner and with an actual power that is close to the selected rated power while the actual power of the first induction heating device is reduced to such a degree as to not exceed the maximum load of the outer conductor.

### CROSS REFERENCE TO RELATED APPLICATIONS

This application is a continuation of PCT/EP2007/010540, filed Dec. 5, 2007, which in turn claims priority to DE 10 2006 058 874.6, filed on Dec. 6, 2006, the contents of both of which are incorporated by reference.

### FIELD OF THE INVENTION

The invention relates to a method according for controlling induction heating devices of an electric cooking appliance, such as in particular of an induction hob.

### BACKGROUND OF THE INVENTION

It is known, for example from EP 1 018 793 A2, that in cyclically operated heating devices such as the radiant heating devices of a hob, where a plurality of heating devices need to be connected to one phase conductor of a power supply connection, the cycle times may be shifted in such a way that, where joint operation with in each case the desired power is impossible to achieve due to the total power, that the power-on times are organized such that at a given instant in each case only one heating device is connected to the phase conductor. This may indeed be possible with cyclically operated heating devices, but it is not advisable for continuously operated induction heating devices.

### SUMMARY

One problem underlying the invention is that of providing a method which allows prior art problems to be avoided and with which in particular an advantageous and sensible option and resultant actuation of induction heating devices of the above-mentioned type may be provided.

This problem is solved in one embodiment by a method having the features of claim 1. Advantageous and preferred configurations of the invention are the subject matter of further claims and are explained in greater detail below. The wording of the claims is incorporated by express reference into the content of the description.

Provision is made for the induction heating devices to be connected to a power supply connection with at least one phase conductor, or for the at least two induction heating devices to be connected to the same phase conductor. This phase conductor comprises a maximum load, which must not be exceeded at any time, since in particular corresponding fuse-protection of the phase conductor or of the power supply connection is provided by way of a fuse box. The induction heating devices are intended to be connected to a common phase conductor. A first induction heating device is intended to be operated with a high desired power, in particular at its maximum desired power or a so-called “boost power.” Such a boost power serves, in particular when bringing food to the boil or at the start of a boiling process, to operate the induction heating device for a short time, for example of up to 10 or 15 minutes, with ultra high power and then to return to the normal maximum desired power. A further or second induction heating device is intended to be operated with a lower desired power, this lower desired power advantageously being less than the possible maximum normal or boost power of this second induction heating device. According to one embodiment of the invention, the second induction heating device, i.e., the one operated with the lower desired power, is operated with higher priority and at a power level which is as close as possible to the selected desired power. The other, first induction heating device is reduced to such an extent with regard to its actual power that the maximum power of the phase conductor is complied with at all times.

The above-stated high desired power may amount to at least 90% of the maximum desired power. The above-stated low desired power may likewise amount to at least 90% of the maximum desired power, but is altogether lower than the high desired power.

The invention thus allows, to the advantage or for the operational convenience of an operator, for the relative levels of the respective powers relative to one another to be evaluated in addition to the absolute level thereof and, by a relatively small reduction in the actual power of the first induction heating device with very high power or boost power, for an appropriate space to be provided for the other induction heating device(s). Such a reduction in the actual power of the first induction heating device may amount to at most 20%. Advantageously, it amounts to at most 15% or even only at most 10%. This relatively slight effect on cooking progress is here much less noticeable to an operator or is regarded as less troublesome. If more than two induction heating devices are operated using the same conductor, and one induction heating device is operated with the stated ultra high power, a power reduction thus takes place with regard to this induction heating device operated with ultra high power. The power then freed up is distributed to the other induction heating devices, advantageously with preferred allocation to the one with the lowest set power stage.

Provision may be made for the method to be applied when the second induction heating device is connected to the phase conductor with a selected actual power of up to at most 50% of its maximum power. Then the actual power of the first induction heating device may be reduced, if the maximum load of the phase conductor would otherwise be exceeded, which must be avoided at all costs. In this respect, the method may be implemented in this configuration of the invention when the desired power of the second induction heating device lies in the lower or a low range. In precisely this case, it is highly advantageous if the selected operation with the desired power as actual power takes place immediately after connection of this second induction heating device. Furthermore, it should above all be noted here that, with a low desired power of the second induction heating device, the first induction heating device has to be reduced only relatively slightly with regard to its actual power, in order to provide the power reserve needed for the second induction heating device. In extreme cases, it could indeed be the case that due to the high actual power of the first induction heating device, the second induction heating device cannot be operated at all or only with extremely low actual power. This would definitely be regarded as troublesome by an operator.

Moreover, provision may be made for the method to be applied only in the case where a change in the actual power of the induction heating devices takes place when one of the two induction heating devices, preferably the above-stated first induction heating device, is operated with boost power. With such boost power, operation takes place with briefly increased actual power; said power is thus over the normal intended maximum actual power which this induction heating device may achieve lastingly or in continuous operation. In a still further configuration of the invention it may be provided that, after termination of the desired heating period of the first induction heating device at boost power, if the load reserve of the phase conductor is still sufficient the induction heating devices are operated with the power stage which has been preset or selected by an operator, i.e. in each case with its desired power. In this case, it should as a rule be assumed that the added-together normal maximum continuous actual power of the two induction heating devices lies below the maximum load of the phase conductor.

Such boost power may for example be such that a brief power increase of more than 50% may take place, with in particular for large induction heating devices the normal intended maximum continuous actual power possibly being around 2.3 kW and the boost power 3.7 kW, i.e. significantly greater. The duration of this boost power is advantageously the above-stated 10 or 15 minutes. In the case of conventional power supply connections in a household with three-conductor, 230 Volt connections, maximum load is precisely said 3.7 kW. This would therefore mean that, when operating a large induction heating device with boost power, a second induction heating device connected to the same phase conductor could not be operated at all. The invention may of course also be applied in the case of a single conductor connection, if therefore two or even more induction heating devices are connected to the single phase conductor of a one-phase power supply connection.

It is likewise possible to apply the invention or the method in the case of the combined use of induction heating devices adjustable continuously with regard to power together with radiant heating elements adjusted by way of the on-time ratio, i.e. by way of cyclic operation.

In a further configuration of the invention, provision may be made for the second induction heating device, in particular if it comprises lower normal intended maximum continuous actual power, to take priority over the first induction heating device with higher actual power. Here too, in addition to the effect that in the case of very high powers a relatively small reduction is more likely to be regarded as troublesome, the fact is exploited that a power reduction of for example 10% in the case of the heating device operated with higher actual power makes a bigger difference to the lower power than the other way around.

Moreover, with the above-stated control method provision may be made for various status indications or signals to be provided to an operator. It may for example be provided that, in the case of selection for the desired power of a second induction heating device of a lower power than that of the first induction heating device using the same phase conductor and where the second induction heating device is operated with an actual power below the selected desired power, corresponding information is output to an operator. Likewise, in what is a more normal case for the method according to the invention, provision may be made for the first induction heating device with the greater actual power or the above-described boost power to be reduced in power and for this to be indicated to an operator. Such a display or indication of information to an operator may proceed in the form of a specific indication of the desired power or the actual power. It is, for instance, deemed advantageous to alternately display a desired power and an actually established actual power reduced relative thereto, with at least one of the two being indicated with flashing. Provision may for instance be made to display the desired power and the actual power alternately, display of the actually established power being effected by flashing representation of precisely this power.

The above and further features follow not only from the claims, but also from the description and the drawing, the individual features being realized in each case alone or several together in the form of sub-combinations in an embodiment of the invention and in other fields and may constitute advantageous, per se protectable embodiments, for which protection is here claimed. Subdivision of the application into individual sections and intermediate headings does not limit the general applicability of the statements made thereunder.

### BRIEF DESCRIPTION OF THE DRAWING

FIG. 1 illustrates schematically an exemplary embodiment of the invention and shows a hob with four rings and two power units, which are in each case connected to a phase conductor of a power supply connection.

### DETAILED DESCRIPTION OF THE EXEMPLARY EMBODIMENT

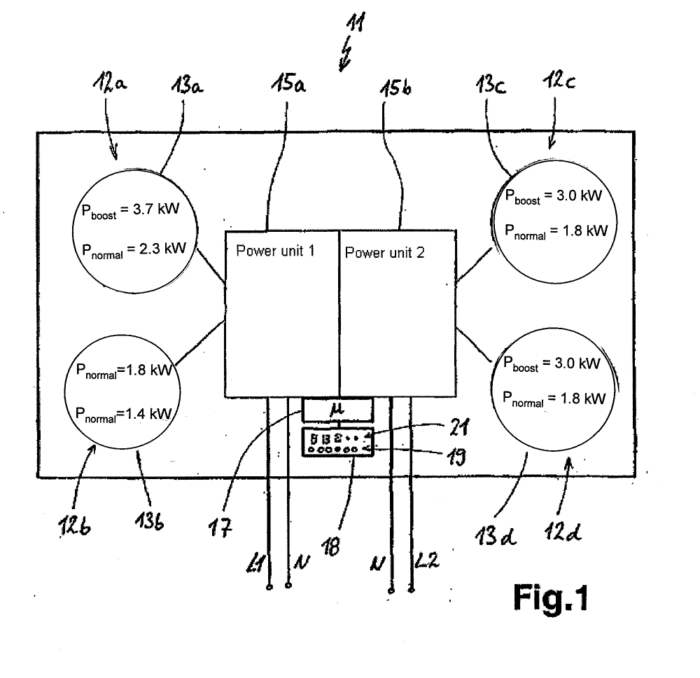

FIG. 1 shows a hob 11 with four rings (heating areas) 12a-12d. The rings 12a-12d are in each case formed of induction heating devices 13a -13d and covered by a hob plate, not shown. The left-hand two induction heating devices 13a and 13b are supplied with power by a left-hand power unit 15a, which is connected to the phase conductor L1 and the return conductor N of a power supply connection. The right-hand two induction heating devices 13c and 13d are supplied with power by a right-hand power unit 15b, which is connected, in the case of the same power supply connection, to the phase conductor L2 and the return conductor N. For the sake of simplicity the power values of the induction heating devices 13a-13d are indicated in FIG. 1. They in each case comprise a power Pₙₒᵣₘₐₗ, which is the maximum power for “normal continuous operation”. Moreover, the induction heating devices 13a-13d may however produce a briefly increased power, namely the power P_{Boost}, in particular for bringing food to the boil. It should be noted that this boost power is significantly above the normal power, being sometimes greater by more than half, such as for example with the induction heating device 13a. Such boost powers are known to a person skilled in the art in particular for induction heating devices.

The two power units 15a and 15b contain power electronics, as a rule converters or the like, for the respective induction heating devices 13a to 13d. They are actuated by a controller 17. The controller 17 is in turn connected to an operating device 18, which comprises operating elements 19 and illuminated displays 21, for example seven segment displays or simply lamps or LEDs. An operator may effect power setting or modification by way of the operating elements 19. This is displayed visually by way of the illuminated displays 21.

The following tables, Table 1 and Table 2 reveal how power distribution occurs for the induction heating device 13a with the very high boost power P_{Boost} and the induction heating device 13b with the significantly lower normal power Pₙₒᵣₘₐₗ. These two induction heating devices are connected to the same power unit 15a. Table 2 illustrates this for the induction heating device 13c in boost operation with P_{Boost} and for the induction heating device 13d in normal operation.

TABLE 1

| | Power | | |
|---|---|---|---|
| Ring 1 | reduction | Available residual | Ring 2 power where |
| [P_{Boost}] | [%] | power for ring 2 | Pₙₒᵣₘₐₗ = 1400 W = 100% |
| 3700 W | 0% | 0 W | 0% |
| 3700 W | −10% | 370 W | 26% |
| 3700 W | −15% | 555 W | 40% |
| 3700 W | −20% | 740 W | 53% |

TABLE 2

| | Power | | |
|---|---|---|---|
| Ring 3 [P] | reduction | Available residual | Ring 2 power where |
| [P_{Boost}] | [%] | power for ring 4 | Pₙₒᵣₘₐₗ = 1800 W = 100% |
| 3000 W | 0% | 700 W | 39% |
| 3000 W | −10% | 1000 W | 56% |
| 3000 W | −15% | 1150 W | 64% |
| 3000 W | −20% | 1300 W | 72% |

It is clear from the tables that, with in each case, a slight reduction in the power of the induction heating device in boost operation, a sufficient power reserve may be provided for the other induction heating device operating normally using the same power unit or it may be operated with for instance a third to a half of the maximum normal power, i.e. a for instance medium power stage.

In the event of a reduction in the power of an induction heating device in boost operation, the illuminated displays 21 may show alternately on the one hand a symbol for the selected boost power stage, for example a given number, and on the other hand another symbol or another number. An additional symbol may also flash, which symbol normally indicates boost operation of an induction heating device.

1. A method for controlling induction heating devices comprising a first induction heating device and a second induction heating device in an electric cooking appliance, said induction heating devices connected to a power supply connection comprising at least one phase conductor, said at least one phase conductor capable of providing power at a maximum level, comprising the steps of:
receiving a first input from a user for a first desired power level of said first induction heating device of said electric cooking appliance, said first desired power level at a maximum continuous operating power level or a boost power level associated with said first induction heating device,
receiving a second input from the user for a second desired power level of said second induction heating device, said second desired power level at a less than maximum continuous operating power level associated with said second induction heating device;
providing a first actual power to said first induction heating device wherein said first actual power is less than said first desired power level; and
providing a second actual power to said second induction heating device wherein said second actual power is equal to or less than said second desired power level,
wherein said first actual power to said first induction heating device is provided simultaneously with said second actual power to said second induction heating device, and
wherein further said combined first actual power and said second actual power is less than or equal to said maximum load of said at least one phase conductor.

2. The method of claim 1, wherein in case of said first induction heating device, said first actual power is at most 20% less than said first desired power level.

3. The method of claim 1, wherein said second desired power level is at most 50% of a maximum continuous power level of said second induction heating device.

4. The method of claim 1, wherein providing said first actual power to said first induction heating device occurs if said first input from said user for said first desired power level is at said boost power level and said first actual power provided is greater than a maximum continuous actual power level associated with said first induction heating device for at least two minutes.

5. The method of claim 4, wherein said first actual power to said first induction heating device is provided for no more than 15 minutes.

6. The method of claim 4, wherein said first desired power level of said first induction heating device is a boost power.

7. The method of claim 4, wherein after said at least two minutes, said first actual power level is reduced and said second actual power to said second induction heating device is equal to said second desired power level.

8. The method of claim 1, wherein said second induction heating device takes priority over said first induction heating device.

9. The method of claim 8, wherein said second induction heating device takes priority over said first induction heating device when said first desired power level of said first induction heating device of said electric cooking appliance is at a maximum continuous operating power level.

10. The method of claim 1, wherein, in case of providing said second actual power to said second induction heating device wherein said second actual power less than said second desired power level, information is provided on a display to said user indicating said second induction heating device is operating at less than said second desired power level.

11. The method of claim 10, wherein said information is indicated by flashing on said display by alternating a first indicator corresponding to said desired power level and a second indicator corresponding to said actual power level.

12. A system for controlling a plurality of induction heating devices in an electric cooking appliance, comprising:
a power supply conductor, configured to receive household power and provide a maximum operating power for said electric cooking appliance;
a first induction heating device, configured to operate at a first actual power level provided from said power supply conductor;
a second induction heating device, configured to operate at a second actual power level provided from said power supply conductor;
a controller, configured to control said first actual power of said first induction heating device and said second actual power level of said second induction heating device,
said controller configured to receive a first input from a user for a first desired power level of said first induction heating device at either a maximum continuous operating power level or at a boost power level associated with said first induction heating device,
said controller configured to receive a second input from said user for a second desired power level of said second induction heating device, wherein said second desired power level is at most 50% of a maximum continuous power level of said second induction heating device,
wherein said controller is configured to actuate said first induction heating device to operate at said first actual power level that is less than said first desired power level, and
said controller is further configured to actuate said second induction heating device, said second induction heating device actuated to operate at said second actual power level that is equal to said second desired power level, wherein said controller is configured to determine said first actual power level based on said second input, such that said first actual power level and said second actual power level is less than or equal to said maximum operating power for said electric cooking appliance.

13. The system of claim 12 wherein the controller is configured to reduce the first actual power level in response to receiving said second input from said user.
